(19) United States
(12) Patent Application Publication
(10) Pub. No.: US 2010/0052896 A1
(43) Pub. Date: Mar. 4, 2010

(54) FALL DETECTION SYSTEM AND METHOD

(76) Inventor: Jesse Bruce Goodman, Mississauga (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/391,746

(22) Filed: Feb. 24, 2009

Related U.S. Application Data
(60) Provisional application No. 61/190,621, filed on Sep. 2, 2008.
(60) Provisional application No. 61/196,092, filed on Oct. 15, 2008.

(51) Int. Cl. G08B 1/08; G01P 15/00; G08B 23/00; G08B 17/00

(52) U.S. Cl. 340/539.11; 702/141; 340/573.1; 340/584

(57) ABSTRACT

A system and method for detecting falls is disclosed herein. A mobile pressure sensor is used to generate a mobile pressure signal and a reference pressure sensor at a reference height above a surface is used to generate a reference pressure signal. A processor in communication with the mobile pressure sensor and the reference pressure sensor is used to perform the steps of: (i) determining a height above the surface of the mobile pressure sensor based on the reference height and the reference pressure signal and the mobile pressure signal; and (ii) if the height is below a threshold height, determining that a fall has occurred.

### FIELD

Applicant's teachings are related to a system and method for detecting falls.

### INTRODUCTION

Elderly, sick or injured people can be prone to falling accidents. Such individuals may not have the strength or mobility to stand up after a fall has occurred and therefore such a person would likely need help after a fall has occurred. This could be the case even if the fall itself has not caused any injury. Despite the risk of falling, such individuals may be capable of walking on their own. In some cases, such individuals may even be generally capable of living on their own. Regardless of the person's degree of independence, it may be desirable to monitor such an individual so that help can be dispatched when a fall has occurred.

### SUMMARY

In various embodiments, applicants' teachings relate to a system for detecting falls. In various embodiments, the system comprises a mobile pressure sensor, a reference pressure sensor, and a processor. The mobile pressure sensor generates a mobile pressure signal. The reference pressure sensor is at a reference height above a surface and generates a reference pressure signal. In various embodiments, the processor is in communication with the mobile pressure sensor and the reference pressure sensor and performs the steps of: (i) determining a height above the surface of the mobile pressure sensor based on the reference height and the reference pressure signal and the mobile pressure signal; and (ii) if the height is below a threshold height, determining that a fall has occurred. In some embodiments of applicant's teachings, step ii) comprises: if the height is below a threshold height for a time exceeding a threshold time, determining that a fall has occurred.

In various embodiments, the system further comprises a second reference pressure sensor for generating a second reference pressure signal. In some embodiments, the system comprises a plurality of reference pressure sensors for generating a plurality of reference pressure signals.

In various embodiments, the system further comprises a plurality of transceivers, wherein at least one of the plurality of transceivers is proximate to the mobile pressure sensor.

In various embodiments, the processor further performs the steps of: determining which of the first and second reference pressure sensors is closest to the mobile pressure sensor based on a transceiver signal. In some embodiments, the closest of the reference pressure sensors is determined by the strength of the signal received from the transceiver proximate to the mobile pressure sensor at each of the other of the plurality of transceivers. In some embodiments, step (i) comprises determining a height above a surface of the mobile pressure sensor based on the mobile pressure signal, the reference height and the reference pressure signal of the closest of the first and second reference pressure sensors.

In various embodiments of applicant's teachings, the system further comprises a first dampening cover for surrounding the mobile pressure sensor. In some embodiments, the system further comprises a second dampening cover for surrounding the reference pressure sensor. In various embodiments, the damping cover comprises: (a) an acoustic semi permeable foam; and (b) a lumped heat source, wherein the lumped heat source is adapted to receive the mobile pressure sensor.

In some embodiments of applicant's teachings, the mobile pressure sensor is housed in a wristband device. In various other embodiments, the mobile pressure sensor is housed in a pendant style device. In some embodiments of applicant's teachings, the mobile pressure sensor and the processor are housed in a wristband device. In some embodiments of applicant's teachings, the processor is housed in a wall mounted device.

In some embodiments of applicant's teachings, the system further comprises an accelerometer and wherein the processor performs the further step of: (iii) if the accelerometer detects movement above a threshold amount of movement, then determining that a fall has occurred. In various embodiments of applicant's teachings, the accelerometer is housed in a wristband device.

In various embodiments, applicants' teachings relate to a method of detecting falls. In various embodiments, the method includes the steps of (a) generating a reference pressure signal at a first location at a reference height above a surface; (b) generating a mobile pressure signal; (c) determining a height of a source of the mobile pressure signal above the surface based on the reference pressure signal and the mobile pressure signal; and (d) if the height is below a threshold height, determining that a fall has occurred. In some embodiments, step d) comprises: if the height is below a threshold height for a time exceeding a threshold time, determining that a fall has occurred.

In some embodiments, the method further comprises generating a second reference pressure signal at a second location at a second reference height above the surface. In various embodiments, the method further comprises determining the closest of the first and second location to the source of the mobile pressure signal.

In various embodiments of applicant's teachings, step (c) comprises: determining a height above a surface of the source of the mobile pressure signal based on the mobile pressure signal and the closest of the first and second reference pressure signal.

In some embodiments of applicant's teachings, step (c) comprises: (i) determining a height above sea level of the first location; (ii) determining a height above sea level of the source of the mobile pressure signal; (iii) determining a height above sea level of the surface; and (iv) determining a height of the mobile pressure signal above the surface.

In various embodiments, the height above sea level is determined according to the relationship

$$P ( ht ) := {P}_{o} \cdot {e}^{\frac{- M \cdot g \cdot ht}{R \cdot {T}_{sea}}} .$$

In various embodiments, applicants' teachings relate to a wristband mounted device. In some embodiments, the wristband device comprises: (a) a pressure sensing circuit for generating a mobile pressure signal; (b) a receiver for receiving a reference signal; and (c) a processor coupled to the pressure sensing circuit, the transceiver, and the memory module; wherein the processor is adapted to determine a height of the wristband device above a surface based on the reference signal and the mobile pressure signal.

In some embodiments, the wristband device further comprises: (d) a memory module for storing sea level temperature and sea level pressure. In various embodiments, the processor is adapted to determine a height of the wristband device above a surface based on the reference signal, the mobile pressure signal, the sea level temperature and the sea level pressure.

In various embodiments, applicants' teachings relate to a device for providing a reference pressure signal. In some embodiments, the device comprises: (a) a pressure sensing circuit for generating a reference pressure signal; (b) a transmitter coupled to the pressure sensing circuit for transmitting the reference pressure signal; (c) a memory module for storing sea level temperature, sea level pressure, and a reference height above a surface; and (d) processor coupled to the pressure sensing circuit, a transmitter, and memory module. In some embodiments, the processor is adapted to determine a height of the device above a surface based on the reference signal, the mobile pressure signal, the sea level temperature and the sea level pressure. In some embodiments, the processor is adapted to determine a height of the surface above sea level based on the reference height above the surface.

In some embodiments of applicant's teachings, a mobile pressure sensor is worn by a person who is being monitored for falls. In some embodiments, the mobile pressure signal generated by the mobile pressure sensor along with a reference pressure signal is used to determine an absolute height of the mobile pressure sensor above a surface. The surface could for example, be a floor of the dwelling of the person being monitored for falls. In various embodiments, based on the height above the surface (and in some embodiments based on other factors as well), it is determined whether or not the wearer of the mobile pressure sensor is on the floor as a result of a fall or other incident. As will be discussed in greater detail below, the determination of an absolute height above a surface avoids false positive fall detection incidents that can occur if only changes in height were determined or if only relative changes in pressure readings between the mobile pressure sensor and the reference pressure sensor were monitored. An example of a fall detection system in which relative changes in pressure and relative changes in height are monitored is disclosed in European Patent No. EP 1 642 248 B1. As will be discussed in greater detail below, the applicant has realized that monitoring only relative changes in pressure or relative changes in height could indicate that a change of height of a given magnitude has occurred but it may not indicate that the monitored individual has fallen to the floor. In addition, such a system or method may not indicate that the person has fallen or moved to the floor if the person had started from a relatively low position (such as for example a fall out of a bed) given that the change in height or pressure would be relatively small and therefore may not be interpreted as a fall. Accordingly, in various embodiments of applicant's teachings, the absolute height above a floor is determined in order to assess whether or not the monitored individual is on the floor as a result of a fall or other incident.

### DRAWINGS

The skilled person in the art will understand that the drawings, described below, are for illustration purposes only. The drawings are not intended to limit the scope of the applicant's teachings in any way.

FIGS. 1A and 1B are block diagram illustrating the basic elements of a fall detection system according to various embodiments of Applicant's teachings;

FIG. 2A illustrates a block diagram of a wristband device incorporating mobile pressure sensor of FIGS. 1A and 1B according to various embodiments of Applicant's teachings;

FIG. 2B illustrates a perspective view of wristband device of FIG. 2A according to various embodiments of Applicant's teachings;

FIG. 3A illustrates a block diagram of a wall module incorporating mobile pressure sensor of FIGS. 1A and 1B according to various embodiments of Applicant's teachings;

FIG. 3B illustrates a perspective view of wall module of FIG. 3A according to various embodiments of Applicant's teachings;

FIG. 4A illustrates a front perspective view of a damping cover according to various embodiments of Applicant's teachings used to protect the mobile and reference pressure sensors of FIGS. 1A and 1B;

FIG. 4B illustrates a rear perspective view of a damping cover according to various embodiments of Applicant's teachings used to protect the mobile and reference pressure sensors of FIGS. 1A and 1B;

FIG. 5A is a block diagram of a fall detection system according to various embodiments of Applicant's teachings;

FIG. 5B is a block diagram of the coordinator module of FIG. 5A;

FIGS. 6A and 6B are graphs illustrating the relationship between air pressure and altitude; and

FIGS. 7 to 11 are graphs illustrating various signals produced by various embodiments of fall detection system in various situations.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or a combination of both hardware and software.

Applicant's teachings are related to a system and method for detecting falls. The systems and methods described herein can be applied to any appropriate It is possible to predict major falls that result in serious injury by detecting a prior tendency to have minor falls not resulting in major injury. Through a process of detecting minor falls, it is possible to identify an individual at risk of a major fall, investigate causes and define interventions that will reduce likelihood of a subsequent major fall.

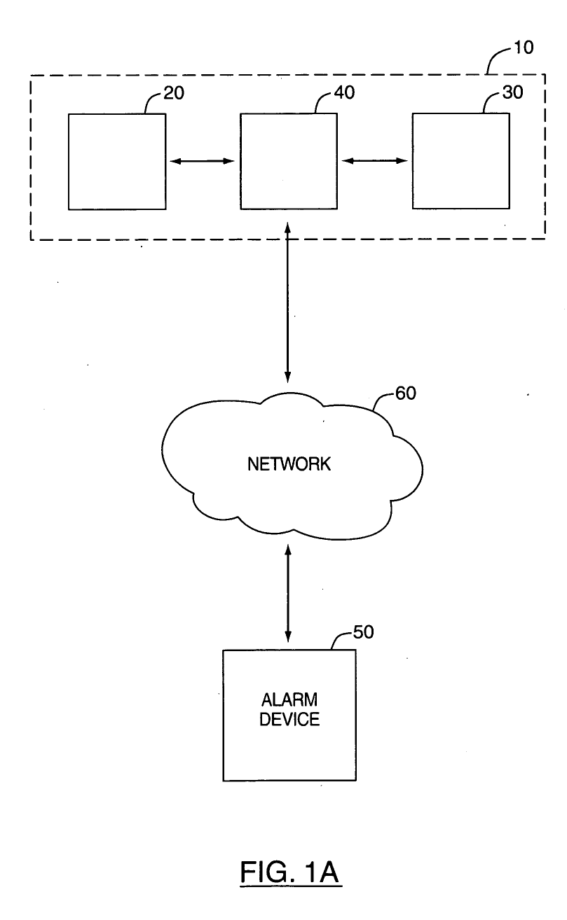

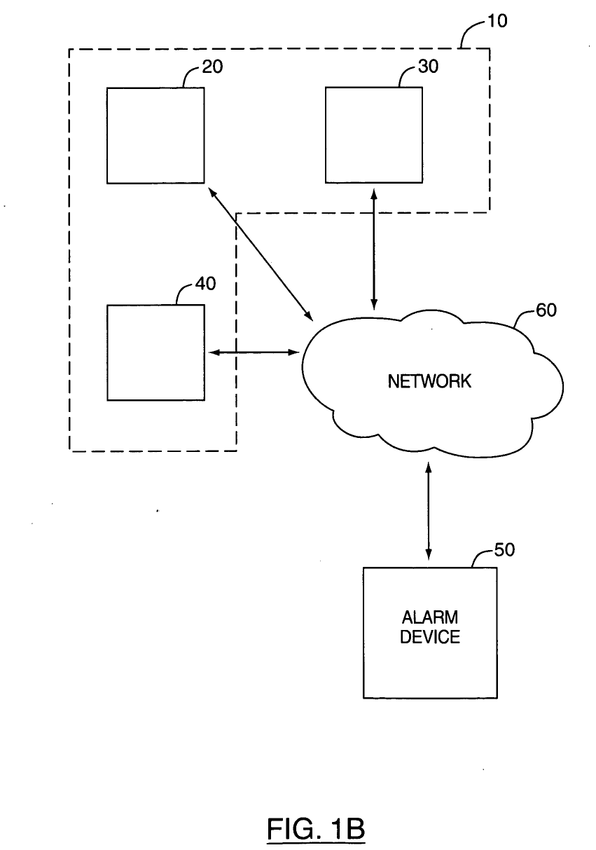

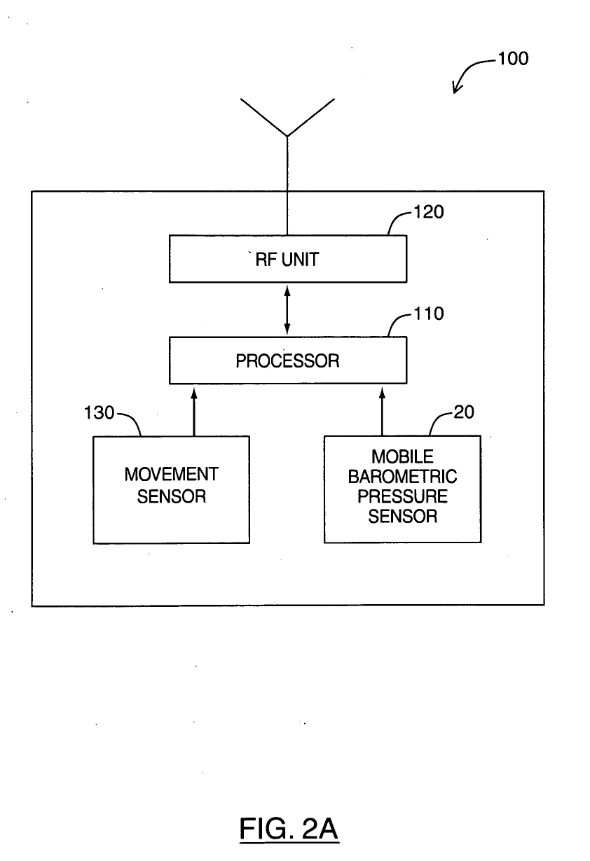

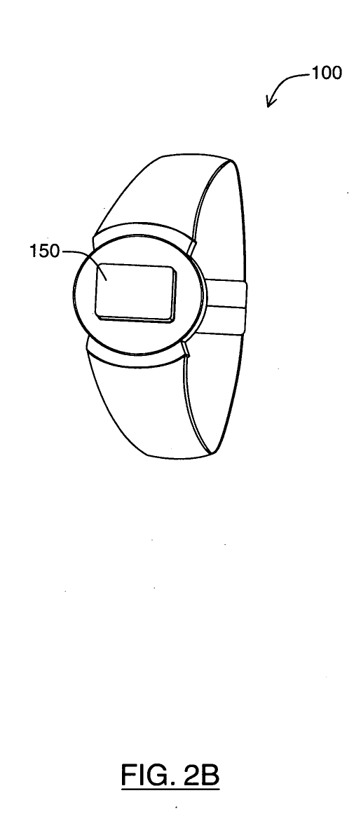

Reference is now made to FIGS. 1A and 1B, which illustrates fall detection system 10. Fall detection system 10 comprises a mobile sensor 20, reference pressure sensor 30, and a processor 40. Optionally, fall detection system 10 may also include a motion sensor (see FIG. 2A), which may for example be an accelerometer.

Mobile barometric pressure sensor 20, is worn by a person, such as for example, but not limited to, an elderly, sick, or injured person, who is being monitored for falling incidents. More specifically, mobile pressure sensor 20, can be incorporated in a device, such as for example, but not limited to a wristband mounted device or a pendant style device, that is worn by such a person. If a motion sensor is also used it can be incorporated within the same device as mobile pressure sensor 20.

Reference barometric pressure sensor 30 is installed at a known height and provides a reference pressure signal for the known height. Reference pressure sensor 30 can for example be mounted on a wall at a fixed and known height above the floor on which the wearer of mobile pressure sensor 20 is situated.

In some embodiments, mobile pressure sensor 20 and reference pressure sensor 30 are each barometric pressure sensing integrated circuits, such as for example but not limited to BMP085 produced by Bosch Sensortech. In such embodiments, mobile pressure sensor 20 and reference pressure sensor 30 comprise an altimeter or height meter based on the measurement of air pressure.

Processor 40 receives the mobile pressure signal from mobile pressure sensor 20 and the reference pressure signal from reference pressure sensor 30. In some embodiments processor 40 also receives a motion signal from a motion sensor. It should be understood that as used herein “receiving mobile pressure sensor signal” is not intended to describe receiving the exact signal generated by the mobile pressure sensor but rather can refer to a modified signal representative of the original signal generated by mobile pressure sensor 20. Thus, for example, processor 40 need not be directly coupled to mobile pressure sensor 20 but rather several different devices and transmission media may be coupled between mobile pressure sensor 20 and processor 40. Accordingly, mobile pressure signal may be modified and transformed in several different ways before being received by processor 40.

Based on the inputs received, processor 40 determines whether a fall has occurred. As part of this determination, processor 40 determines the absolute height of the mobile pressure sensor 20 above the floor. The manner in which this is determined will be described in greater detail below. As will be described in greater detail herein, if a fall is detected, then an alarm signal can be communicated to an alarm device 50 through network 60. In some embodiments, an alarm signal is generated if the height of the mobile device is determined to be below a threshold height. In other embodiments, an alarm is generated based on height data as well as other data including but not limited to motion data such as acceleration data.

Alarm device 50 can be any appropriate device that is operated by any appropriate person. In some embodiments, alarm device 50 could, for example, be a computer at a monitoring centre. An employee at the monitoring centre could if necessary dispatch paramedics to the location of the person that is being monitored.

It should be understood that communication links illustrated in FIGS. 1A and 1B are illustrative only and that other devices may be used as intermediaries. For example, processor 40 may communicate with a web server. In addition, alarm device 50 may communicate with that same web server. In addition, there may be a coordinator module that coordinates the communication between various components of fall detection system 10 including a web server.

In other embodiments, alarm device 50 can be a computing device operated by a caregiver, retirement house staff (if the individual is located at a retirement house), hospital staff (if the person is located at a hospital), relative, friend, or any other appropriate interested party. For example, alarm device 50 can be a portable communication device such as a cell phone or PDA. In this manner, any appropriate person can be alerted of the fall.

In some embodiments, there can be multiple alarm devices 50, each of which can be owned and operated by a different individual. For example, an alarm can be activated at a call centre and also sent to a portable communication device of a relative.

Network 60 can be any appropriate network including but not limited to the Internet, local area network, wireless network, satellite network, a cellular network, or a telephone network.

In some embodiments, processor 40 is incorporated in a device with mobile pressure sensor 20. In other embodiments, processor 40 is incorporated in a device with reference pressure sensor 30. In other embodiments, processor 40 may be part of a separate device that communicates with both mobile pressure sensor 20 and reference pressure sensor 30. In various other embodiments, a processor 40 can be incorporated with each device having mobile pressure sensor 20 as well as each device that has a reference pressure sensor 30.

In various other embodiments, processor 40 may be included in an alarm device 50 or a separate device such as a computer at a call centre. Although FIG. 1A illustrates processor 40 as being on the same side of the network as mobile pressure sensor 20 and reference pressure sensor 30, processor 40 may communicate with either of the pressure sensors (20, 30) through network 60 as illustrated in FIG. 1B. In such an embodiment, the reference pressure signal and mobile pressure signal can be transmitted through network 60 and processed by processor 40. Each of the devices incorporating mobile sensor 20 and reference pressure sensor 30 can communicate through network 60. Alternatively, one device can communicate with the other, which would send both signals across network 60.

It should be understood that although FIGS. 1A and 1B only illustrate one mobile sensor and one reference sensor as being monitored by an alarm device, fall detection system can comprise a plurality of mobile pressure sensors 20 and a plurality of reference pressure sensors 30 located in various locations.

In some embodiments, fall detection system 10 can resolve differences in air pressure that correspond to a vertical displacement of approximately 0.25 m. In various other embodiments, fall detection system 10 can resolve differences of height with an accuracy of greater than 0.1 m.

Reference is now made to FIG. 2A, which illustrates a block diagram of a wristband device 100, incorporating mobile pressure sensor 20. Although FIG. 2A illustrates a wristband device, as mentioned above, other devices could be used, including but not limited to a pendant.

Wristband device 100 includes mobile pressure sensor 20, processor 110, RF (radio frequency) unit 120 and movement sensor 130. In some embodiments, wristband device 100 does not include a movement sensor. In some embodiments, RF unit 120 is a transmitter. In other embodiments, RF unit 120 is a transceiver.

As described above, mobile pressure sensor 20, measures air pressure and provides a mobile pressure signal. Processor 110 receives input signals from mobile pressure sensor 20 and movement sensor 130. Processor 110 drives RF unit 120 to transmit signals, such as the mobile pressure signal, to other devices.

Optionally, processor 110 could also comprise processor 40 of FIG. 1. In such embodiments, RF unit 120 comprises a transceiver and can receive signals from other devices. Such signals may include a reference pressure signal from wall module 200, which will be described in greater detail below.

Movement sensor 130, can be used to provide data about the motion of the wearer. As mentioned above movement sensor 130 can comprise an accelerometer. The use of movement sensor 130 can provide additional information that maybe useful in determining whether a fall has occurred. More specifically, an accelerometer can be used to detect motion and posture changes of the wearer that are associated with the fall. Processor 40 can use any appropriate algorithm to combine the height data with the motion data to generate better fall detection accuracy

Reference is now made to FIG. 2B, which illustrates a perspective view of wristband device 100. As mentioned above, other embodiments may use other means of allowing the user to wear the device than a wristband. In various embodiments wristband device 100 is made to be waterproof.

In various embodiments, the device is designed such that it is easy for the wearer to keep the device on at all times. This can be accomplished in any appropriate manner. For example, a wristband device does not need to be removed when changing clothing, sleeping, washing hands, or bathing. This is in contrast to a device that is worn over one's clothing in such a way that it must be removed to remove the clothing. An example of such an item could be a belt, which would be removed when changing clothes. A device that is not designed to be worn comfortably at all times may cause the user to neglect wearing it at times and as a result a fall may not be detected when it occurs.

In some embodiments, wristband device 100 also comprises a panic button 150. This button can be used by the wearer to cause an alarm signal to be transmitted to alarm device 50. The button can be used as a backup for generating an alarm signal. In various embodiments, the primary alarm detection function is achieved by monitoring the height data or a combination of the height data with other data such as motion data.

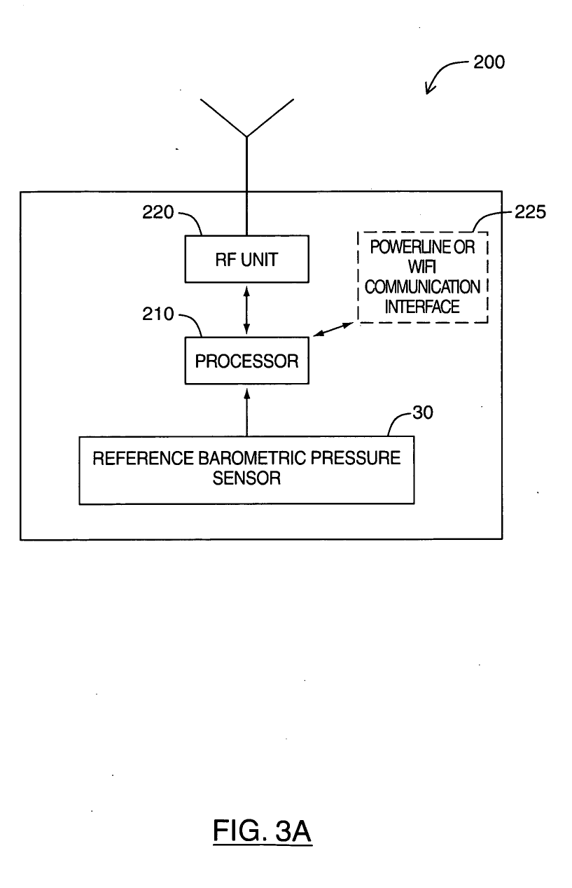

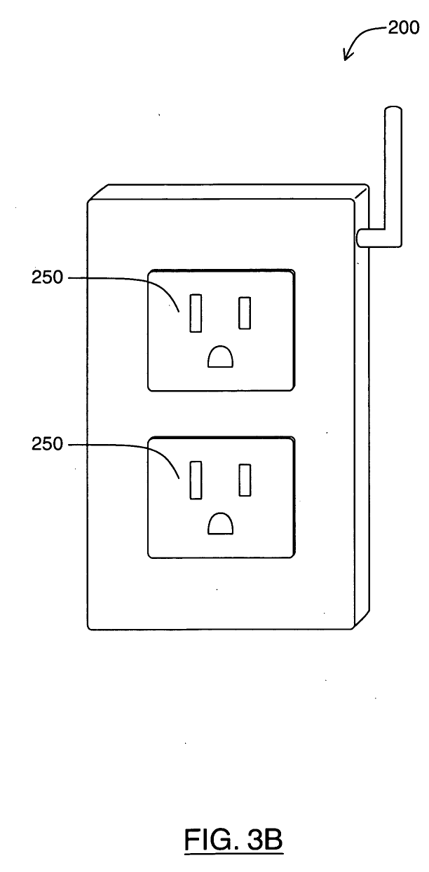

Reference is now made to FIG. 3A, which illustrates a block diagram of a wall module 200 incorporating reference pressure sensor 30 of FIG. 1. Wall module 200 includes reference pressure sensor 30, processor 210, RF unit 220. In various embodiments, RF unit 220 is a transceiver. It should be understood that wall module 200 can also include other communication interfaces for providing communication over any appropriate communication link, which may include but is not limited to powerline communication network, RF based network, Ethernet, WiFi, fiber optic and cable. Thus, for example, various embodiments include a secondary interface unit 225, which can be a Powerline or WiFi Communication interface. This is intended to be an example only and it should be understood that in other embodiments any other number and type of interfaces can be included.

Although reference pressure sensor 30, is described as being incorporated in a wall module, it is not intended to exclude other embodiments. For example, reference pressure sensor 30 could be incorporated in a ceiling mounted unit or a unit placed on the floor, where the actual sensor may or may not be elevated from the floor. Any appropriate, mounting, suspension or placement of reference pressure sensor 30 could be used.

Processor 210 accepts input signals from reference barometric pressure sensor 30. In some embodiments, RF unit 220 transmits reference pressure signal to other devices such as for example, a device containing processor 40, which could be wristband device 100 or a standalone device.

In some embodiments, processor 210 comprises processor 40 of FIG. 1. In such embodiments, RF unit comprises both a transmitter and a receiver. The RF unit receives signals from other devices such as the mobile pressure signal that is transmitted by wristband device 200. RF unit 220 can also receive Processor 210, based on the various inputs it receives, determines whether a fall has occurred. Based on the determination, processor 210 may cause an alarm signal to be transmitted. This can be accomplished by transmitting a signal through an Ethernet connection (not illustrated) to alarm device 50 through network 60. Alternatively RF unit 220 can transmit an alarm signal to a separate device that in turn transmits an alarm signal to alarm device 50 through network 60.

In various embodiments, wall module 200 is mounted at a known height above a floor. In some embodiments, the particular height above the floor at which the wall module 200 is mounted is not restricted as long as the height is known. In various embodiments, the known height is a fixed height.

In some embodiments, wall module 200 can be installed at any appropriate height and need not be installed at a specific height. Specifically, in some embodiments, processor 210 can accept the height at which wall module 30 is mounted as an input. This input can be applied in any appropriate manner including, but not limited to, through an RF signal detected by RF unit 220. In other embodiments, wall unit 200 can be pre-programmed with a specific height. The wall unit can then be installed at the specific height.

Given that wall module 200, is at known height, reference pressure sensor 30 is also at a known height. Thus, pressure sensor 30 can be used to produce a reference pressure signal for the known and fixed height. This can in turn be used to provide a height reference for other pressure sensors. Specifically, given the reference pressure signal produced by pressure sensor 30 and the mobile pressure signal produced by mobile pressure sensor 20, processor 40 can determine an absolute height of wristband device 100 above the floor. This will be discussed in greater detail below.

There are various factors that can cause rapid barometric pressure changes that are of greater magnitude than a drop of a given height. Relatively rapid barometric pressure sensor readings are frequently of greater magnitude than the pressure change associated with a drop of a given height such as a 0.3 m. Such pressure changes can result from relatively rapid changes in temperature, ambient barometric change and other environmental effects. Such factors may include but are not limited to a door opening, passing by a window, fans or central air vents. Ambient pressure changes of significance can include a door opening and closing, passing by a window, fans or central air vents as well as many other influences.

To ensure correspondence between pressure readings, from a reference barometric pressure sensor 30 and from a worn, mobile barometric pressure sensor 20, the system and method according to Applicant's teachings ensures that reference sensor 30 and mobile sensor 20 are in sufficiently close proximity. Thus, in one embodiment, a wall module 200 is installed in each room that the wearer of wristband device 100 has access to. For example, if the user lives in a house or an apartment, a wall module 200 can be mounted in each room of the house or apartment.

In addition, depending on the size and architecture of a room, the ambient pressure can vary within a room. In some embodiments, multiple wall modules 30 can be installed in one room to account for differences in ambient pressure within the room. In other cases, wall module 200 can be placed strategically within the room so as not to be affected by factors that may cause incorrect readings.

The use of multiple wall modules 200 allows for wristband device 100 to be paired with the wall module 200 that is closest to it. The use of a mobile sensor 20 and reference sensor 30 that are in close proximity to each other allows for effective elimination of errors due to environmental effects or noise unrelated to possible falls.

The wristband device 100 can be paired with the closest wall module 200 in any appropriate manner. In some embodiments, this is achieved through analysis of the strength of the signal transmitted by RF unit 120 of wristband device 100 at various locations in the dwelling. This can be accomplished through the use of transceivers distributed in the dwelling. In one embodiment, each wall module 200 comprises such a transceiver. A computer program could be used to track the location of the wrist device and pair it with the closest wall module 200. In one embodiment, the location tracking can be achieved with an accuracy of better than 10 m. In various embodiments, the association of wristband device 100 with a particular wall module with a room level accuracy location tracking ability.

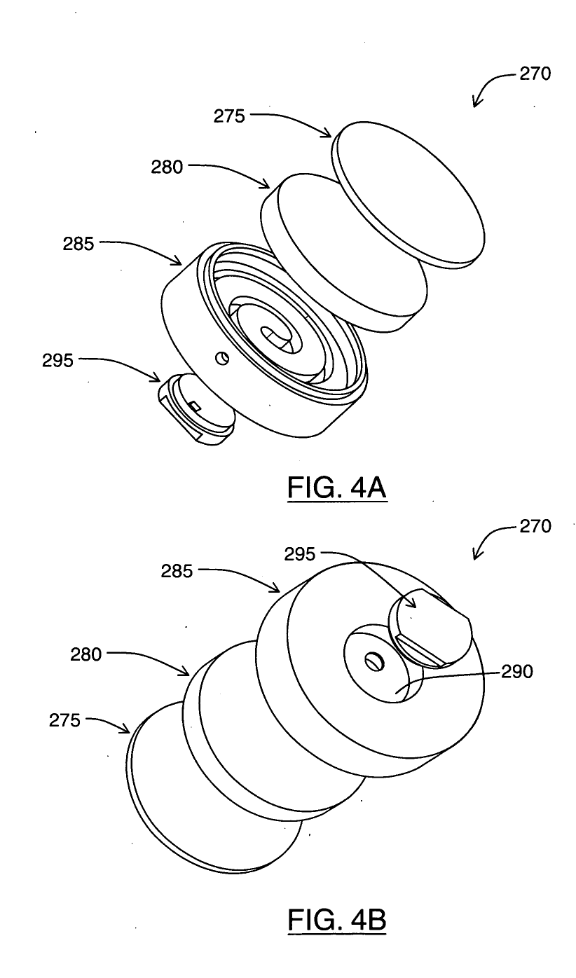

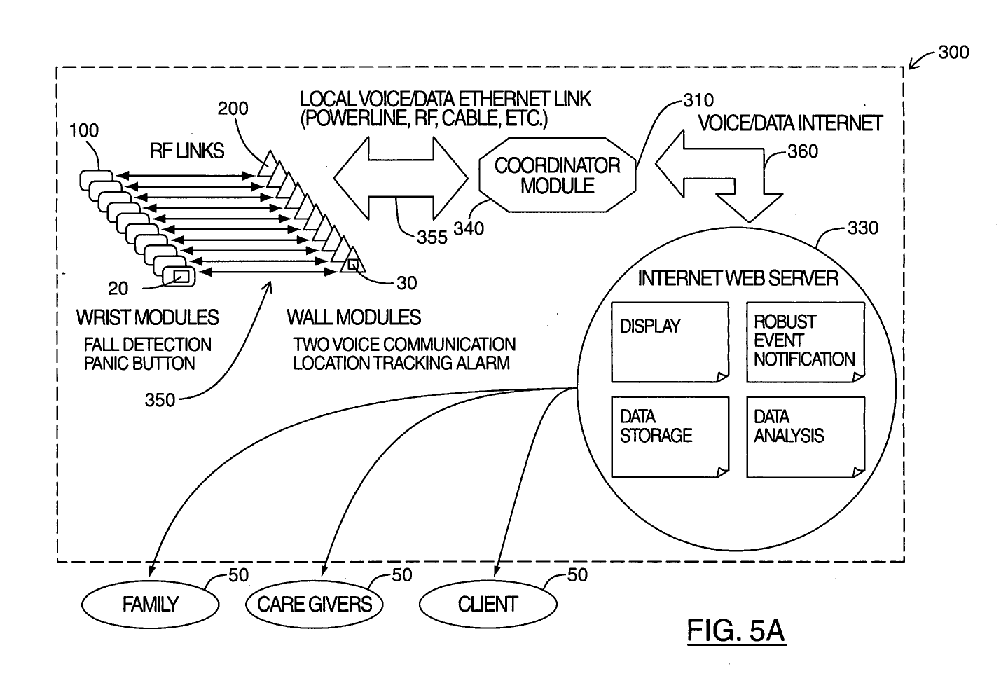

Furthermore, in various embodiments pressure sensors 20 and 30 are shielded through the use of a damping cover (illustrated in FIGS. 4A and 4B) to protect them from rapid pressure changes, temperature changes and mechanical vibrations. This will be discussed in greater detail below with reference to FIG. 4A and FIG. 4B.

In addition, signal processing can be used to remove the effects of environment noise, whether the noise is the result of pressure, temperature or kinetic noise. Specifically, adaptive filter methods used in single or multiple digital filter processes, can be used to extract noise from barometric pressure sensor data in order to allow the data to be used to provide 0.3 m vertical height resolution. In some embodiments, the height resolution is more accurate than 0.1 m.

In addition, it should be understood that multiple wristband devices 100 can be used in the same room. Thus, for example, multiple individuals can be monitored in the same room or dwelling. Each wall module 200 can track and distinguish each wristband device 100 separately. This can be accomplished in any appropriate manner including but not limited to the use of unique identifier signals for each wristband device 100. Specifically, each wristband device 100 could emit an identifying signal that distinguishes it from each of the other wristband devices 100 used in the dwelling.

It should also be understood that fall detection system 10 is not limited to a particular floor but could also be used to monitor individuals as they move between floors. For example, a wall module 10 could be installed in an elevator, in a stairway, and on landing between floors.

Reference is now made to FIG. 3B, which illustrates a perspective view of an embodiment of wall module 30. In some embodiments, wall module 30 can plug directly into an electrical wall socket and thereby receive power for operating its electrical circuitry components. In addition, various embodiments of wall module 30 can also include a battery to provide back up power in case of an electrical power failure.

For such embodiments, mounting wall module 30 includes plugging in the module into an electrical wall socket. Wall module 30 can also include an electrical socket 250 from which another electrical device can be powered. This allows the electrical wall socket to be used by another device.

It should be understood that various embodiments include various other features. For example, in some embodiments, two-way voice communication may be provided for between the individual being monitored and another individual. In some embodiments, this may be provided by including a communication device in either the wall module 200 or the wristband device 100.

As mentioned above, pressure sensors 20 and 30 can be shielded in order to protect them from pressure shock waves and fast temperature changes that create sensor noise. Reference is now made to FIG. 4A and FIG. 4B, which illustrate front and rear perspective views respectively of a damping cover 270 that is used to protect the sensor. A mass designed to store heat and prevent rapid changes in sensor temperature, sometimes known as a lumped heat source, is a component of a damping pressure sensor element. Damping cover 270 comprises a heat cover 275, acoustic semi permeable foam 280, and lumped heat source 285. Pressure sensor 295 (which could be either mobile pressure sensor 20 or reference pressure sensor 30) is inserted in cavity 290 in lumped heat source 285. In addition, in some embodiments, a thermally conductive epoxy is applied between pressure sensor 295 and lumped heat source 285.

Cover 270 prevents rapid temperate swings from occurring at pressure sensor 295. In addition, cover 270 also muffles the effects of air movement around pressure sensor 295. The effects of temperature swings and airflow around the sensor can contribute to noise, which in turn reduces the effective height resolution that can be achieved.

Thus, in various embodiments, the use of damping cover 270 improves the vertical measurement resolution that can be achieved. In some embodiments, the resolution can be further enhanced by use of data processing techniques to further cancel noise present in the mobile and reference pressure signals. This data processing can be performed by any appropriate component of the system including but not limited to processor 40.

As mentioned above, various embodiments of fall detection system 10 are able to resolve the vertical displacement of mobile pressure sensor 20 above a floor with various degrees of accuracy. The particular effective resolution is dependent on various factors including but not limited to, the quality of the pressure sensors, the use of algorithms to cancel noise and the use of shielding to protect pressure sensors from noise, as well as other factors. Various embodiments may or may not utilize one or more of these features or may do so to different extents and therefore have different effective height resolutions.

In addition, in various embodiments, pressure sensor readings can change due to sensor aging effects. In some embodiments, recalibration is performed from time to time in order to compensate for sensor aging effects. In various embodiments, wall modules 200 are maintained at a fixed height. Given that average ambient temperature remains stable and sensors 30 remain at the same fixed height, the aging effects of pressure sensors 30 can be accounted for. In some embodiments, this can be accomplished by adjusting the average reference pressure reading of pressure sensor 30 to its historical average value.

In contrast, wrist modules 100, do not remain at a fixed height. Therefore, in various embodiments wrist modules 100 are intermittently recalibrated. In some embodiments, this is accomplished by the user bringing the wrist module 100 in close proximity to a wall module 200. This brings the wrist module 100 to a position at which it should produce a similar pressure sensor reading to the wall module 200 and it can be recalibrated on that basis. In some embodiments, this recalibration is performed periodically. In various embodiments, the period is a month.

In some other embodiments, the intermittent recalibration is performed at night while the user is in bed sleeping. This provides pressure readings at a consistent height. In some embodiments, the pressure sensor 20 can be recalibrated based on for example, historical data for that height. In some embodiments, motion sensor data can be used to confirm that the wrist module is not moving significantly during recalibration. In some embodiments, this recalibration is performed periodically. In various embodiments, the period is a month.

In various other embodiments, calibration can be performed by obtaining pressure sensor data while the user is walking on a specific floor of their residence. This data can be averaged over a period of time. When the person is walking the hand (and therefore wrist module 100) is usually held at a characteristic height. The data collected in this manner can be used to compensate for aging compensation purposes. For example, in some embodiments, the data can be used to recalibrate pressure sensor 20 such that it produces a consistent average reading when the user is walking. In some embodiments, this recalibration is performed periodically. In various embodiments, the period is a month.

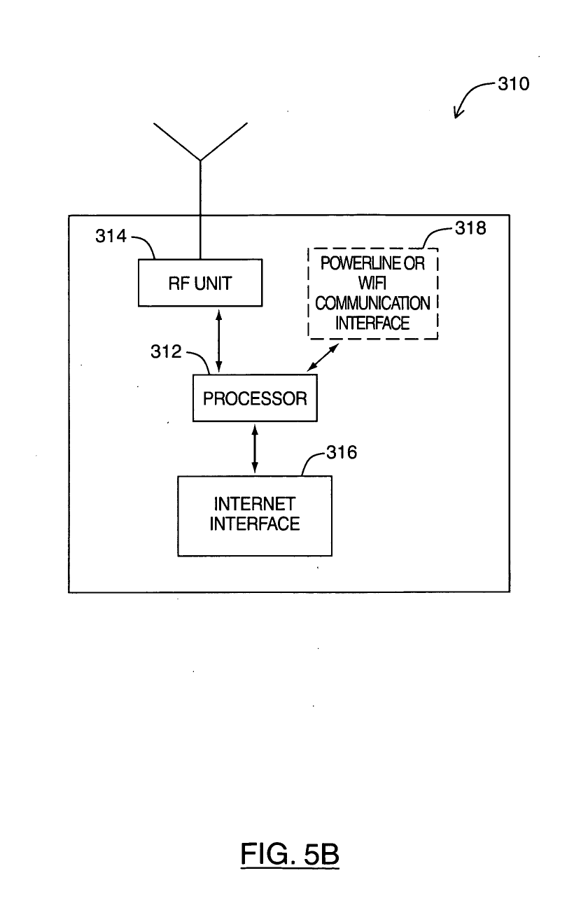

Reference is now made to FIG. 5A, which illustrates a block diagram of a fall detection system 300. Fall detection system 300 comprises a plurality of wrist modules 100, a plurality of wall modules 200, one or more coordinator modules 310, one or more alarm devices 50, an Internet web server 330, and data links 360. Fall detection system 300 corresponds to some of the embodiments of fall detection system 10 illustrated in FIG. 1A.

As described above, wrist modules 100 comprise mobile pressure sensor 20 and wall modules 200 comprise reference pressure sensor 30. In addition, in some embodiments coordinator module 310 comprises processor 40. In other embodiments, Internet web server 330 comprises processor 40. In yet other embodiments, processor 40 resides in a computing device coupled to web sever 330. In still other embodiments, processor 40 resides in each wrist module 100 or wall module 200. In other embodiments, processor 40 is included in each wrist module 100, wall module 200, and coordinator module 310.

Coordinator module 310 communicates with each of the wristband devices 100 and wall modules 200 in order to monitor each individual of interest at a particular location, which could for example be a house or other dwelling. In some embodiments, coordinator module 310 communicates directly with wall modules 200 while communication between coordinator module 310 and wrist modules 100 occurs through wall modules 200. More, specifically, in various embodiments, RF links 350 provide a means of communication between wrist modules 100 and other devices of fall detection system 300. RF links 350 can be any appropriate RF link such as for example but not limited to ZigBee™. In various other embodiments, any appropriate wireless communication link can be used for communication between wrist modules 100 and other devices of fall detection system 300. Communication between one wall module 200 and another wall module 200 and between wall modules 200 and coordinator module 310 occurs through communication link 355, which can be implemented using any appropriate communication link including but not limited to a powerline communication network, RF based network, Ethernet, WiFi, fiber optic and cable. In some embodiments in which Power Line Communication (PLC) network is utilized, a bandwidth of 14 Mbps or greater is utilized. This bandwidth allows the function of two way voice communication to be distributed to all wall modules 200 from a coordinator module 310.

In addition, in various embodiments, coordinator module 310 or wall modules 200 can also communicate with other security and safety devices, which may include but are not limited to smoke detectors, carbon monoxide detectors, motion sensors, intrusion sensors. Communication between these various devices can occur over any appropriate communication link.

In various embodiments, coordinator module 310 is installed at each house or dwelling where at least one monitored person is located. Coordinator module 310 coordinates communication of data between Internet web server 330 and wristband devices 100 and wall module 200.

In some embodiments, coordinator module 310 communicates with Internet web server 330 in any appropriate manner. Communication with an Internet based server can occur through any appropriate communication link including but not limited to ASDL, Cable line and common telephone lines. For example, in some embodiments coordinator module 310 comprises an Internet router. In other embodiments, coordinator module 310 communicates with an Internet router, which in turn communicates with web server 330 in any appropriate manner. In other embodiments, coordinator module 330 includes a transceiver for sending and receiving data. In such embodiments, Internet web server is coupled to a transceiver. Communication can occur in any appropriate manner such as for example, but not limited to General Packet Radio Service (GPRS).

In addition, although not illustrated, it should be understood that coordinator module 310 can be coupled directly or indirectly to any appropriate alarm device, such as for example a cell phone, through any appropriate data channel such as for example GSM voice. The coordinator module 310, in turn links to the wall modules 200 through any appropriate communication link. As mentioned above, in some embodiments, this is an RF link, while in other embodiments, a wired link can be used, such as for example but not limited to a powerline communication link. In this manner, a person operating the alarm device can communicate with a monitored individual through their own alarm device.

In various embodiments, Internet web server 330 coordinates transmittal of information to various alarm devices 50. In some embodiments, various alarm devices can view information and data relevant to specific wristband devices 200. In this manner each alarm device 50 can be linked to one or more wristband devices 100 of fall detection system 300 to monitor one or more persons. In addition, Internet web server 330 can perform various data analysis and processing functions. In some embodiments, Internet web server 330 processes the data received in various ways, such as for example performing filtering functions, in order to eliminate the effects of noise. Filtering the effects of noise can further enhance the height resolution of the system. In other embodiments, one or more processors, such as processor 40, perform these functions. As described above, one or more processors 40 can be distributed throughout fall detection system 10.

Reference is now made to FIG. 5B, which illustrates a block diagram of coordinator module 310. Coordinator module 310 comprises a processor 312, RF unit 312, Internet interface 316 and in some embodiments a secondary interface unit 318, which can be a Powerline or WiFi Communication interface. In some embodiments, Internet interface 316 is utilized to communicate with Internet web server 330 through any appropriate internet data link, which can include but is not limited to cable, ADSL, dial up, or a cellular modem. It should be understood that other embodiments use other communication links to communicate with one or more servers or with alarm devices and therefore in such embodiments Internet interface 316 is replaced by the appropriate type of interface(s). In addition, in various embodiments, coordinator modules have a battery back up for allowing monitoring to be continuous despite power outages.

In addition, in some embodiments, coordinator module 310 also comprises one or more other communication interfaces for providing communication over any appropriate communication link, which may include but is not limited to a powerline communication network, a RF based network, Ethernet, WiFi, fiber optic and cable. Thus, for example, various embodiments include a secondary interface unit 318, which can be a Powerline or WiFi Communication interface. This is intended to be an example only and it should be understood that in other embodiments any other number and type of interfaces can be included.

In some embodiments, powerline interface 318 is used to communicate with wall modules 200. In other embodiments, Internet interface 316 is utilized to communicate with Internet web server 330 through any appropriate internet data link, which can include but is not limited to cable, ADSL, dial up, or a cellular modem. It should be understood that other embodiments use other communication links to communicate with one or more servers or with alarm devices and therefore in such embodiments Internet interface 316 is replaced by the appropriate type of interface(s). In addition, in various embodiments, coordinator modules have a battery back up for allowing monitoring to be continuous despite power outages.

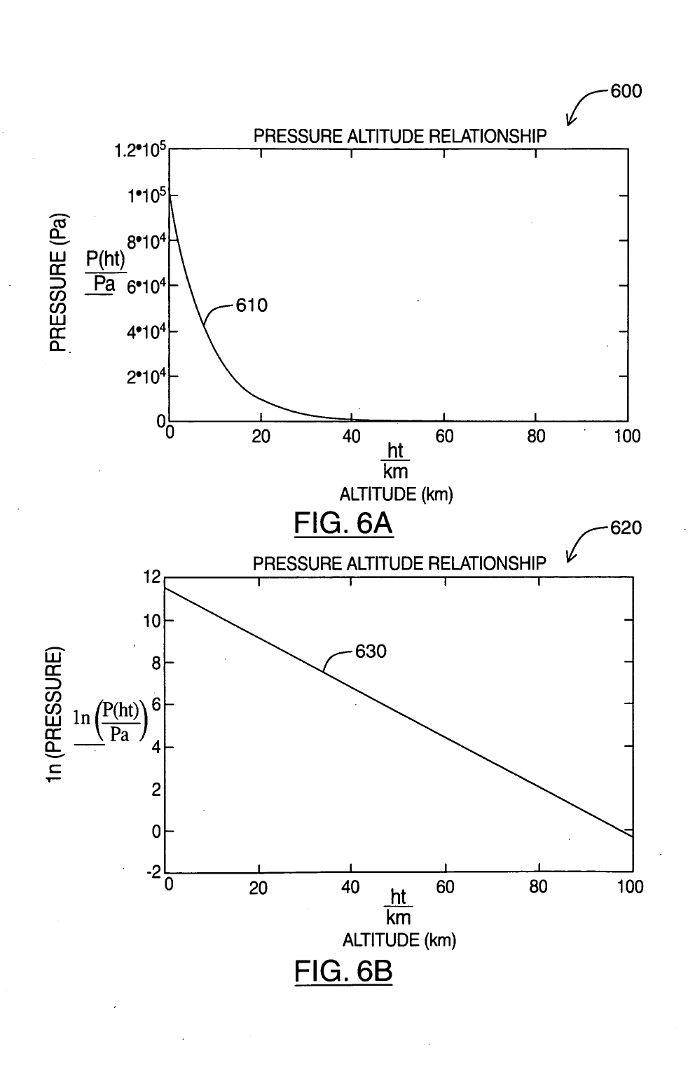

As mentioned above, in some embodiments, various data processing and analysis techniques are used to minimize the effects of noise and/or to provide better height resolution. Reference is now made to FIG. 6A and FIG. 6B, which illustrate graphs (610 and 620) showing the relationship between barometric pressure and altitude. The relationship between pressure and altitude is logarithmic and is given by the equation:

$$P ( ht ) := {P}_{o} \cdot {e}^{\frac{- M \cdot g \cdot ht}{R \cdot {T}_{sea}}}$$

where ht is the height in meters, P_{O} is the atmospheric pressure at sea level, Tₛₑₐ is the average temperature at sea level expressed in Kelvin, M=0.02897 kg/mole and is the average molecular mass of atmosphere, g is the local value for gravity, R=8.314510 joule/(K·mole) and is the gas law constant.

The logarithmic nature of the relationship is reflected in curve 610 of graph 600. Graph 620 can be obtained from graph 600 by taking the natural logarithm of the y-axis variable. This produces a linear relationship between the y-axis and the x-axis variables of graph 620 thereby producing a straight line 630.

In various embodiments, the above equation is used to determine the absolute height of each wall module above sea level. This in turn allows for a determination of the height of the floor relative to sea level. Knowing the absolute height of the reference pressure sensor 30, places it at a specific place on curve 610 or 630. This placement on the curve allows for a more accurate determination of the height of mobile pressure sensor 20 above sea level, which can then be used to determine an absolute height above the floor.

In various embodiments, each wristband device 100 and wall module 200 comprise a memory module where local sea level pressure and temperature can be stored. Both the modules can also comprise a processor for calculating the height of the module from the above equation. In some embodiments, each module is provided with a flash memory module that has a logarithmic look up table for use in calculating the height. In various embodiments, if the logarithmic look up table is not accurate enough to produce all values, then interpolation is used to produce the desired value.

In some embodiments, the local sea level pressure and temperature values stored in the memory modules of wristband device 100 and wall module 200 are periodically updated. In some embodiments, this update occurs twice every day; whereas, in other embodiments, the update occurs more frequently. In some embodiments, the update occurs through a network connection. In some embodiments, web server 330 updates the see level pressure and temperature values stored in the memory modules of wristband device 100 and wall module 200.

In various embodiments, wall module 200 transmits a number of parameters wristband device 100. At least a portion of the data transmitted to wristband device 100 from wall module 200 is sufficient for a processor in wristband device 100 to determine the height of the wristband device 100 above the floor. For example, in various embodiments, wall module 200 transmits some combination of the following parameters: the reference pressure, the reference height (i.e. the height at which the wall 200 module is mounted above the floor), the height of the wall module above sea level, and the height of floor surface above sea level.

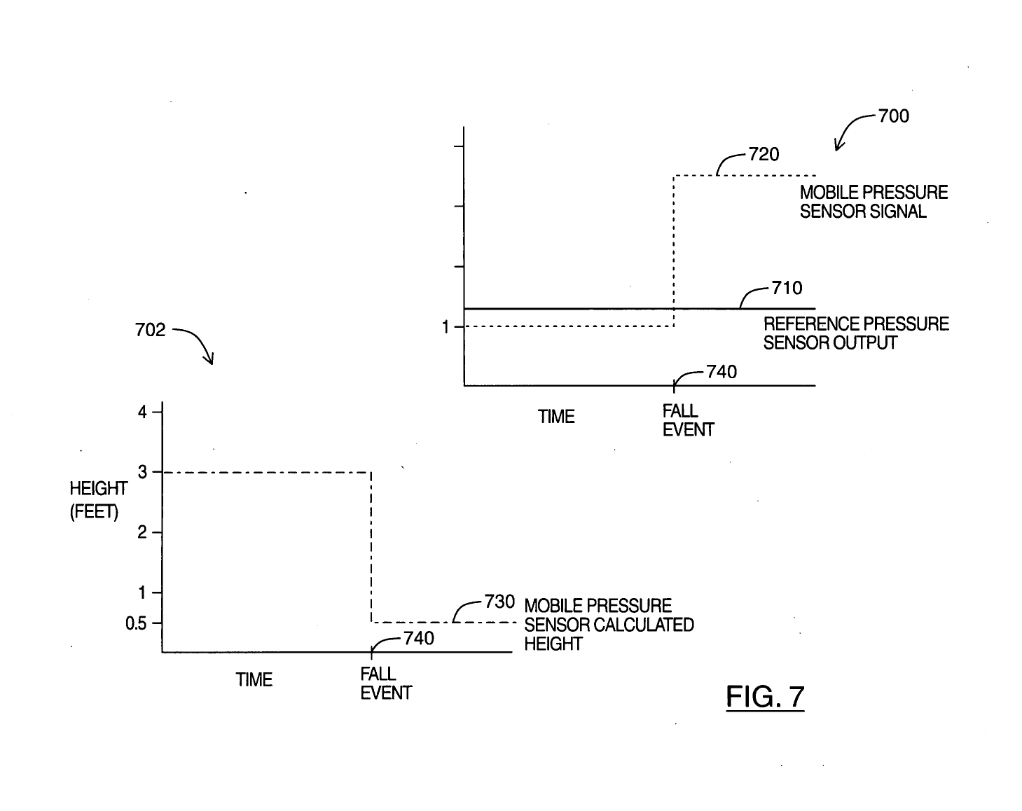

Reference is now made to FIG. 7, which illustrates graphs 700 and 702 showing various signals produced by fall detection system 10 or 300. Plot 710 illustrates the reference pressure sensor output signal produced by reference pressure sensor 30. Plot 720 illustrates the mobile pressure signal produced by mobile pressure sensor 20. Plot 730 illustrates the calculated height of wristband device 100 as determined by processor 40. The calculated height as determined by processor 40 can be averaged over any appropriate time period. For example, in some embodiments, it could be averaged over a 1 minute time period.

The fall of the wearer is indicated at 740. As can be seen, the graph indicates an increase in relative pressure of the wristband device as compared to the wall module. In addition, the calculated absolute height of the wristband device above the floor indicates that the person has fallen. Specifically, prior to the fall, the calculated height, as determined by processor 30, is three feet from the floor. In contrast, after the fall, the calculated average height is 6 inches above the floor. From the height data, it is possible to determine that the person wearing the device has fallen to the ground.

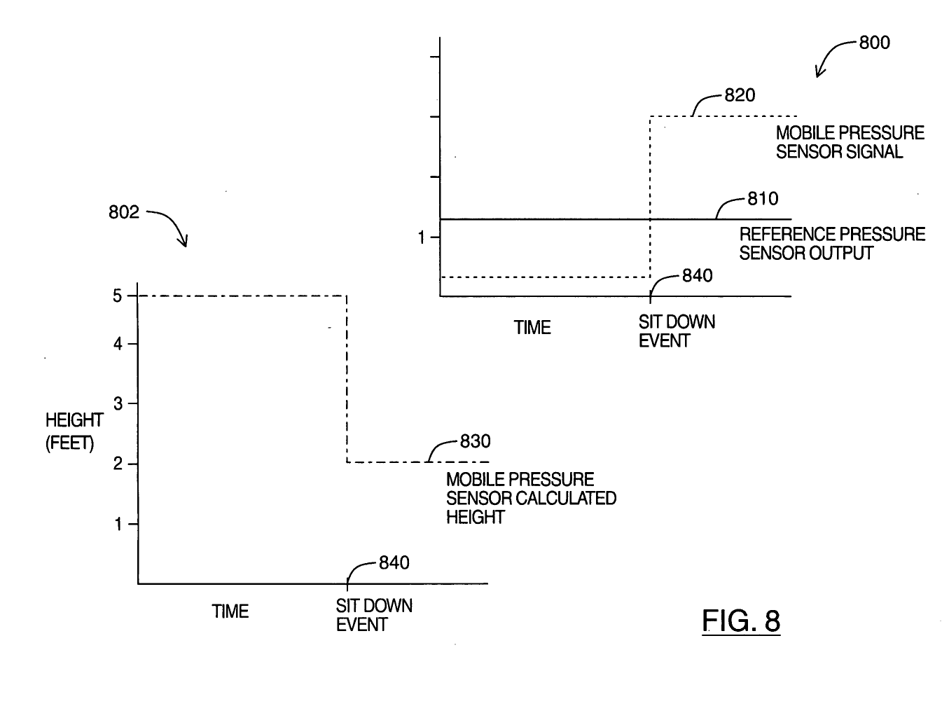

Reference is now made to FIG.8, which illustrates graphs 800 and 802 showing various signals produced by fall detection system 10. Plot 810 illustrates the reference pressure sensor output signal produced by reference pressure sensor 30. Plot 820 illustrates the mobile pressure signal produced by mobile pressure sensor 20. Plot 830 illustrates the calculated height of wristband device 100 as determined by processor 40.

An event at which the mobile pressure sensor signal significantly increases with respect to the reference pressure sensor signal is indicated at 840. If one were to observe only the differences between the two signals one may mistake the event at 840 for a fall. However, the height calculated by processor 40 indicates a height of 5 feet above the floor before the event and a height of 2 feet above the floor after the event. The later height indicates that the wearer is not on the floor.

The illustrated event could for example occur when the wearer is first dusting a shelf (prior to the time indicated at 840) then at the time indicated at 840 the person sits down and rests their hand on their lap. As explained above, processor 40 determines the absolute height above the floor. This is in contrast to determining merely a change in height from before and after the event. Observing only the change in height would lead one to conclude that a fall has occurred. However, the determination of the absolute height indicates a fall has not occurred.

In addition, by determining an absolute height with respect to a surface (e.g. a floor), one can detect falls of a short distance. For example, a person that falls out of their bed may fall a distance that is less than 0.5 m. Fall detection system 10 or 300 could properly identify this as a fall. In contrast, a system that identifies only large changes in barometric pressure as falls would likely not properly identify such a short fall as a fall.

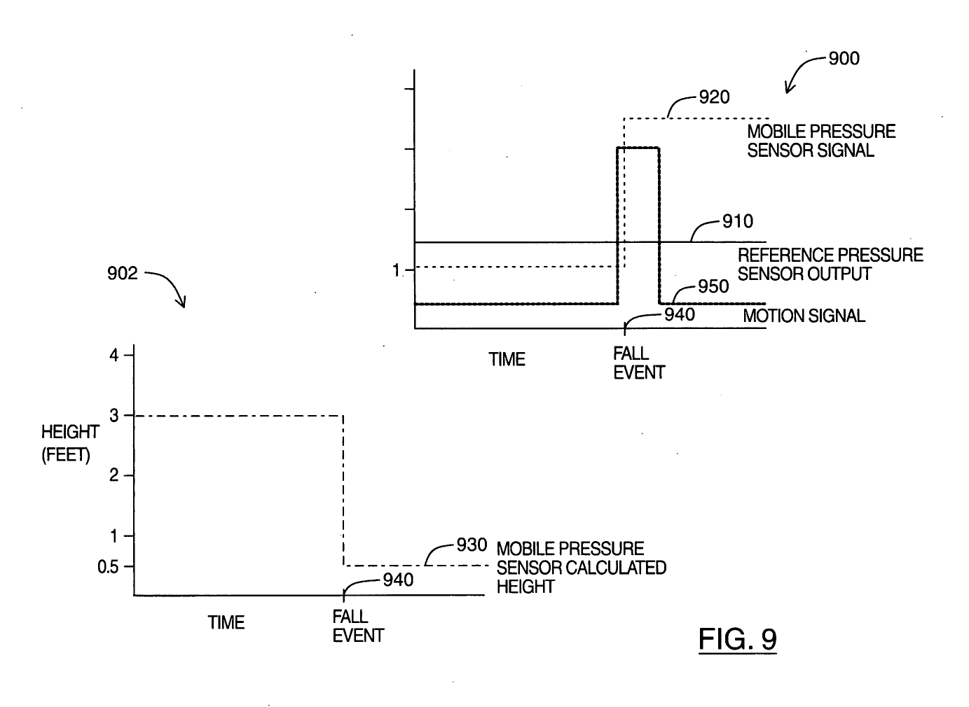

Reference is now made to FIG. 9, which illustrates graphs 900 and 902 showing various signals produced by fall detection system 10 or 300. Plot 910 illustrates the reference pressure sensor output signal produced by reference pressure sensor 30. Plot 920 illustrates the mobile pressure signal produced by mobile pressure sensor 20. Plot 930 illustrates the calculated height of wristband device 100 as determined by processor 40. An event is indicated at 940.

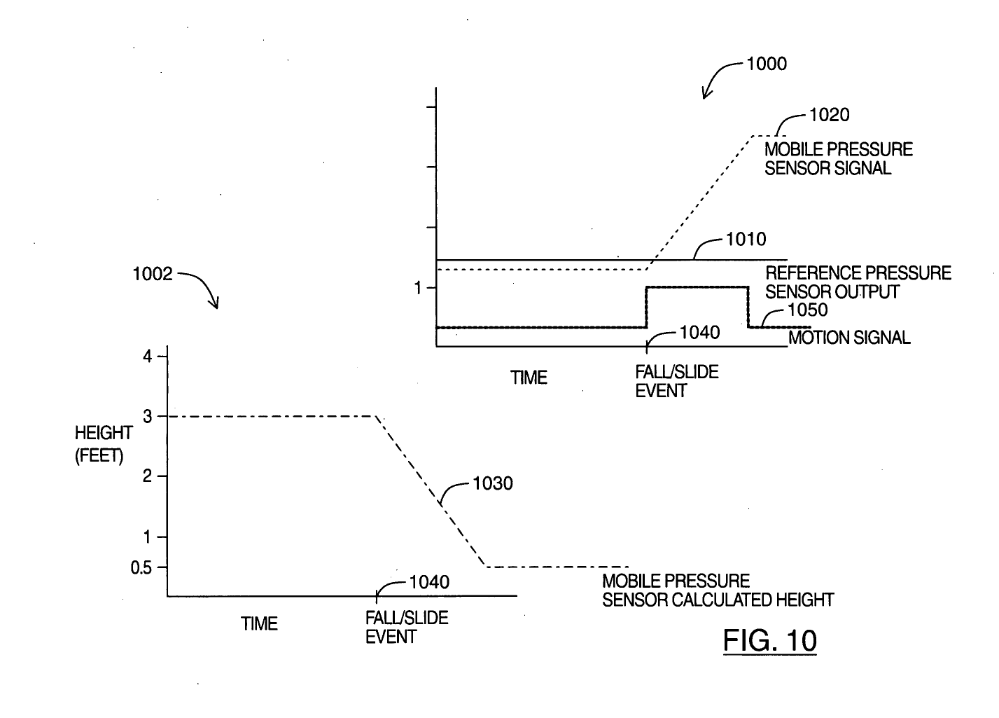

In addition, graph 900 also shows a motion signal 950 such as may be provided by movement sensor 130 of FIG. 2A. In some situations, the motion signal may provide additional information. Event 940 is a person falling down. As can be seen from the graph, both the height data and the motion data indicate that a fall has occurred. However, reliance on only the motion signal can, in some instances, result in false results as discussed in relation to FIG. 10.

Reference is now made to FIG. 10, which illustrates graphs 1000 and 1002 showing various signals produced by fall detection system 10 or 300. Plot 1010 illustrates the reference pressure sensor output signal produced by reference pressure sensor 30. Plot 1020 illustrates the mobile pressure signal produced by mobile pressure sensor 45. Plot 1030 illustrates the calculated height of wristband device 100 as determined by processor 40. An event is indicated at 1040. In addition, graph 1000 also shows a motion signal 1050 such as may be provided by movement sensor 130 of FIG. 2A.

The event indicated at 1040 is a sliding fall in which the wearer slowly slips to the floor. Examining only the motion signal 1050 would not allow one to determine that a fall has occurred. The reason for this is that there is no significant acceleration associated with this fall. Thus, for falls without significant impact forces or accelerations, examining only the motion signal can lead to false negative results. In contrast, examining the calculated height does allow one to determine that a fall has occurred. As can be seen from graph 1000, the calculated height before event 1040 is three feet above the floor whereas the calculated height above the floor after the event is three inches.

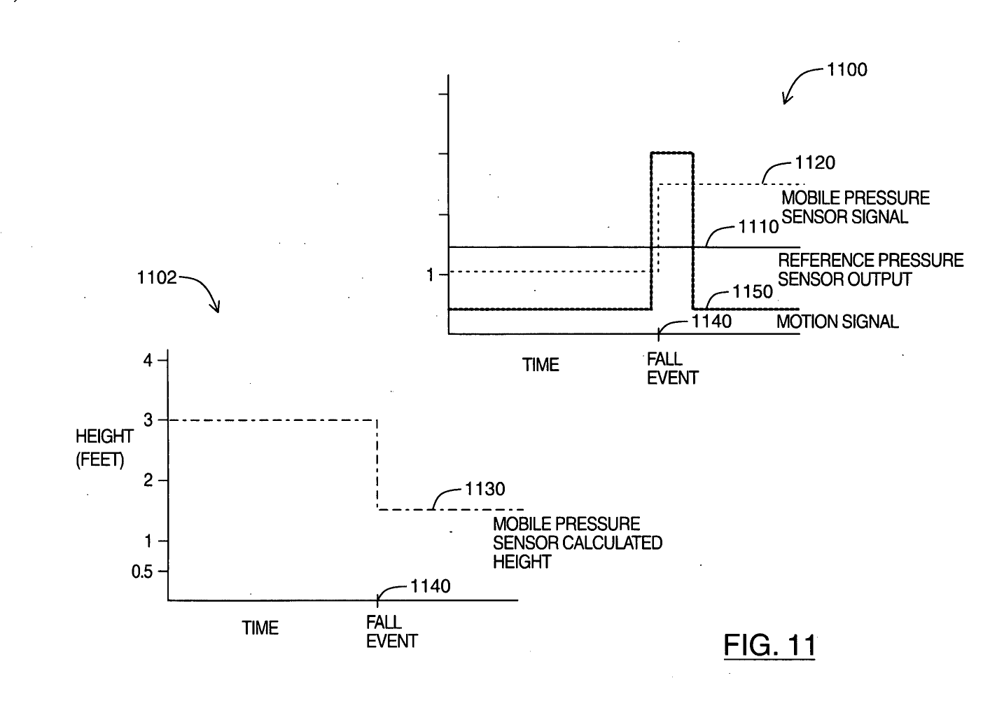

Reference is now made to FIG. 11, which illustrates graphs 1100 and 1102 showing various signals produced by fall detection system 10 or 300. Plot 1110 illustrates the reference pressure sensor output signal produced by reference pressure sensor 30. Plot 1120 illustrates the mobile pressure signal produced by mobile pressure sensor 20. Plot 1130 illustrates the calculated height of wristband device 100 as determined by processor 40. An event is indicated at 1140. In addition, graph 1100 also shows a motion signal 1150 such as may be provided by movement sensor 130 of FIG. 2A.

The event 1140 is a fall in which a person is wedged in between a plurality of surfaces, such as in a corner of the room, in such a manner that the person does not fall all the way to the floor. Thus, the height data indicates that the person has not fallen to the floor. The motion data indicates that some vigorous movement has occurred which indicates that a fall has occurred. In some cases, the use of motion data in combination with the data of the absolute height above the floor can assist in detecting various type of falls in which the user does not actually fall to the floor. Thus, as mentioned above, various embodiments, utilize both height data and motion data to detect falls. Specifically, in some embodiments, if motion sensor, such as for example an accelerometer, indicates vigorous movement that is above a threshold amount of movement, then a fall is detected regardless of the height data. In various embodiments, vigorous movement can be indicated by a series of accelerations in different directions.

While the above description provides examples of the embodiments, it will be appreciated that some features and/or functions of the Applicant's teachings are susceptible to modification without departing from the spirit and principles of operation of the described embodiments. For example, it should be understood that although the embodiments described herein relate to a fall detection system, Applicant's teachings can be applied more generally to systems for monitoring the height of an individual, and individual's body part (such as an arm or wrist), or an object. Accordingly, what has been described above has been intended to be illustrative of the invention and non-limiting and it will be understood by persons skilled in the art that other variants and modifications may be made without departing from the scope of the invention as defined in the claims appended hereto.

1. A system for detecting falls, the system comprising:
a) a mobile pressure sensor for generating a mobile pressure signal;
b) a reference pressure sensor at a reference height above a surface for generating a reference pressure signal; and
c) a processor in communication with the mobile pressure sensor and the reference pressure sensor for performing the steps of:
i) determining a height above the surface of the mobile pressure sensor based on the reference height and the reference pressure signal and the mobile pressure signal; and
ii) if the height is below a threshold height, determining that a fall has occurred.

2. The system of claim 1, wherein step ii) comprises:
if the height is below a threshold height for a time exceeding a threshold time, determining that a fall has occurred.

3. The system of claim 1, further comprising a second reference pressure sensor for generating a second reference pressure signal.

4. The system of claim 3, further comprising a plurality of transceivers, wherein at least one of the plurality of transceivers is proximate to the mobile pressure sensor.

5. The system of claim 4, wherein the processor further performs the steps of:
determining which of the first and second reference pressure sensors is closest to the mobile pressure sensor based on a transceiver signal; and
wherein step (i) comprises determining a height above a surface of the mobile pressure sensor based on the mobile pressure signal, the reference height and the reference pressure signal of the closest of the first and second reference pressure sensors.

6. The system of claim 1, further comprising a first dampening cover for surrounding the mobile pressure sensor.

7. The system of claim 1, further comprising a second dampening cover for surrounding the reference pressure sensor.

8. The system of claim 6, wherein the damping cover comprises:
a) an acoustic semi permeable foam; and
b) a lumped heat source, wherein the lumped heat source is adapted to receive the mobile pressure sensor.

9. The system of claim 1, wherein the mobile pressure sensor and the processor are housed in a wristband device.

10. The system of claim 1, further comprising an accelerometer and wherein the processor performs the further step of:
iii) if the accelerometer detects movement above a threshold amount of movement, then determining that a fall has occurred.

11. A method of detecting falls, the method comprising:
a) generating a reference pressure signal at a first location at a reference height above a surface;
b) generating a mobile pressure signal;
c) determining a height of a source of the mobile pressure signal above the surface based on the reference pressure signal and the mobile pressure signal; and
d) if the height is below a threshold height, determining that a fall has occurred.

12. The method of claim 11, wherein step d) comprises:
if the height is below a threshold height for a time exceeding a threshold time, determining that a fall has occurred.

13. The method of claim 11, further comprising generating a second reference pressure signal at a second location at a second reference height above the surface.

14. The method of claim 13, further comprising determining the closest of the first and second location to the source of the mobile pressure signal.

15. The method of claim 14, wherein step (c) comprises:
determining a height above a surface of the source of the mobile pressure signal based on the mobile pressure signal and the closest of the first and second reference pressure signal.

16. The method of claim 11, wherein step (c) comprises:
i) determining a height above sea level of the first location;
ii) determining a height above sea level of the source of the mobile pressure signal;
iii) determining a height above sea level of the surface; and
iv) determining a height of the mobile pressure signal above the surface.

17. The method of claim 16, wherein the height above sea level is determined according to the relationship
$$P ( ht ) := {P}_{o} \cdot {e}^{\frac{- M \cdot g \cdot ht}{R \cdot {T}_{sea}}} .$$

18. A wristband mounted device, the device comprising;
a) a pressure sensing circuit for generating a mobile pressure signal;
b) a receiver for receiving a reference signal;
c) a processor coupled to the pressure sensing circuit, the transceiver, and the memory module;
wherein the processor is adapted to determine a height of the wristband device above a surface based on the reference signal and the mobile pressure signal.

19. The wristband device of claim 18, further comprising:
d) a memory module for storing sea level temperature and sea level pressure;
wherein the processor is adapted to determine a height of the wristband device above a surface based on the reference signal, the mobile pressure signal, the sea level temperature and the sea level pressure.

20. A device for providing a reference pressure signal, the device comprising:
a) a pressure sensing circuit for generating a reference pressure signal;
b) a transmitter coupled to the pressure sensing circuit for transmitting the reference pressure signal;
c) a memory module for storing sea level temperature, sea level pressure, and a reference height above a surface;
d) a processor coupled to the pressure sensing circuit, a transmitter, and memory module;
wherein the processor is adapted to determine a height of the device above a surface based on the reference signal, the mobile pressure signal, the sea level temperature and the sea level pressure; and
wherein the processor is adapted to determine a height of the surface above sea level based on the reference height above the surface.
